(19) United States
(12) Patent Application Publication
(10) Pub. No.: US 2026/0019508 A1
(43) Pub. Date: Jan. 15, 2026

(54) NETWORK DEVICE, CONTROL METHOD, AND NON-TRANSITORY COMPUTER READABLE STORAGE MEDIUM

(71) Applicant: CANON KABUSHIKI KAISHA, Tokyo (JP)

(72) Inventors: JUNKO SATO, Kanagawa (JP); TAKESHI ISHIKURA, Tokyo (JP)

(21) Appl. No.: 19/262,639

(22) Filed: Jul. 8, 2025

(30) Foreign Application Priority Data
Jul. 12, 2024 (JP) 2024-112525

(51) Int. Cl. H04N 1/00; H04L 67/55

(52) U.S. Cl. CPC H04N 1/00079; H04L 67/55; H04N 1/00464

(57) ABSTRACT

A network device to provide a web page to a web browser via a network, and detect an event corresponding to information displayed on the web page. The web page provided to the web browser executed by a terminal is a web page where a web application is installable onto the terminal in accordance with a user's predetermined operation performed on the web browser. The web application has at least part of a function provided by the network device.

### BACKGROUND

### Field of the Technology

The present disclosure relates to a technology for implementing notification from a network device such as an image processing device to a client device.

### Description of the Related Art

Hitherto, a network device such as an image processing device has been capable of displaying an operation status on a display equipped in the network device. The operation status includes an error occurrence status in the network device, counter information, information on the consumption level of consumables, and a notice from an administrator.

In addition, the network device provides a client device accessed via a network with a function capable of checking the operation status of the image processing device, performing a job operation, making various settings, and so forth. This function is called a remote user interface (hereinafter referred to as a remote UI).

The network device includes therein a web server capable of providing a remote UI. The uniform resource locator (URL) of the remote UI can be accessed by using a web browser (hereinafter referred to as a browser) of the client device. The URL of the remote UI is accessed by, for example, an operation of inputting the IP address of the network device to the browser. Japanese Patent Laid-Open No. 2010-267032 discloses a technology in which a remote UI provided by an image forming device provides, in response to a request for obtaining an error occurrence status or a job status, information regarding the status of a job executed by a target user.

In the above-described related art, however, when a user is to obtain an error occurrence status in the image processing device, information on consumables, or a notice from an administrator, the user is to directly check the display of the image processing device or perform the above-described operation on the browser to access the remote UI and check the information.

A more convenient mechanism of providing information has been requested from a user of the network device.

### SUMMARY

A network device according to an embodiment of the present disclosure includes one or more memories storing instructions, and one or more processors capable of executing the instructions. The instructions cause the network device to provide a web page to a web browser via a network, and detect an event corresponding to information displayed on the web page. The web page provided to the web browser executed by a terminal is a web page where a web application is installable onto the terminal in accordance with a user's predetermined operation performed on the web browser. The web application has at least part of a function provided by the network device.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating an example configuration of a network system.

FIG. 2 is a diagram illustrating an example of a hardware configuration of an image processing device.

FIG. 3A is a diagram illustrating an example of a hardware configuration of a client device.

FIG. 3B is a diagram illustrating an example of a hardware configuration of a push server.

FIG. 4 is a diagram illustrating an example of a software module configuration of the image processing device.

FIG. 5 is a diagram illustrating an example of a software module configuration of the push server.

FIG. 6 is a sequence describing an overview of an entire process executed in the network system.

FIG. 7A is a diagram illustrating a display example on a web browser of a remote user interface (UI) provided by the image processing device.

FIG. 7B is a diagram illustrating a display example on the web browser of the remote UI provided by the image processing device.

FIG. 7C is a diagram illustrating a display example on the web browser of the remote UI provided by the image processing device.

FIG. 8 is a flowchart illustrating the details of a push notification request process performed by the image processing device.

FIG. 9A is a diagram illustrating a display example of a screen of a progressive web application (PWA).

FIG. 9B is a diagram illustrating a display example of a screen of the PWA.

FIG. 9C is a diagram illustrating a display example of a screen of the PWA.

FIG. 10A is a diagram illustrating an example of a program code for generating a push notification request.

FIG. 10B is a diagram illustrating an example of a program code for generating a push notification request.

### DESCRIPTION OF THE EMBODIMENTS

Hereinafter, an embodiment of the present disclosure will be described with reference to the drawings.

A mechanism of providing information on a network device in a network system according to the present embodiment is implemented by using a progressive web application (hereinafter referred to as a PWA). The PWA is a technology in which a web application related to a web site can be used as an application operating on a client device.

The PWA is available to a user without downloading the PWA from an application store run by a vendor providing an operating system (OS), for example, and without installing the PWA onto the client device. For example, the user is able to use the PWA by accessing a PWA-compatible web site from a browser of a client device and downloading the PWA. The contents of the PWA can be freely designed by the provider of the web site.

In the PWA, the use of the function of a service worker makes it possible to provide a push notification to a client device and display an icon on a home screen from an application server built by the provider of the web site or the like. The push notification is implemented via a push server operated by a vendor of a browser or the like. At this time, a predetermined application programming interface (API) supported by the OS or browser of the client device is used.

In the present embodiment, a remote UI provided by a web server of a network device corresponds to a PWA-compatible web site, and is a feature of the embodiment.

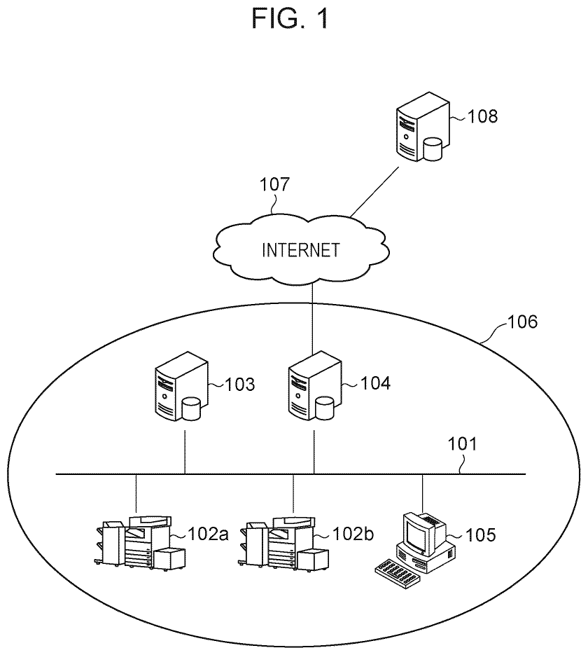

FIG. 1 is a diagram illustrating an example configuration of a network system according to the present embodiment. Referring to FIG. 1, reference numeral 101 denotes a local area network (LAN), reference numeral 102 denotes an image processing device, which is an example of a network device, reference numeral 103 denotes a proxy server, and reference numeral 104 denotes a firewall installed to enhance the security of an intranet. Reference numeral 105 denotes a client device (hereinafter also referred to as a terminal 105 of a user) such as a personal computer (PC) used by a user. The client device 105 is connected to the LAN 101. Reference numeral 106 denotes an intranet environment.

Here, the client device 105 may be a smartphone, a tablet terminal, or the like instead of a PC. Another example of the network device to which the present embodiment is applicable is a device that includes a web server and that is capable of providing a remote UI, such as a network router, a surveillance camera, or a digital medical device.

Reference numeral 108 denotes a push server installed to provide a push service by a vendor of a browser or an OS. The push server 108 mediates communication between the image processing device 102 and the terminal of a user to implement a push notification from an application server to the client device 105 using a PWA described below. In the system illustrated in FIG. 1, the intranet environment 106 and the push server 108 are connected to each other via the Internet 107. It is technically possible to build the push server 108 on an intranet.

The network according to the present embodiment such as the LAN 101 is implemented by any one of or a combination of wired communication and wireless communication such as Wi-Fi or a mobile network.

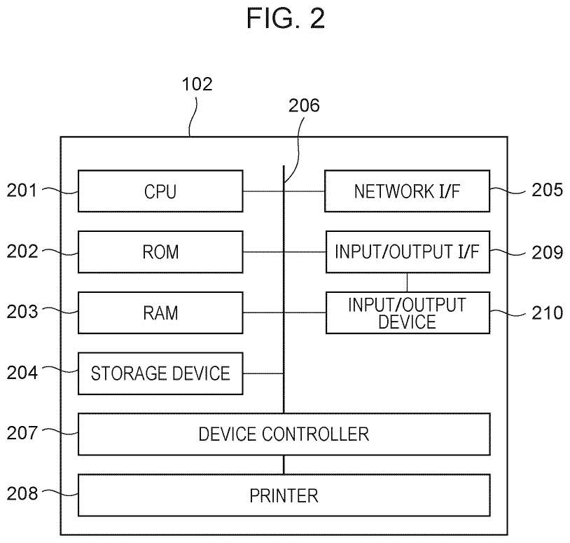

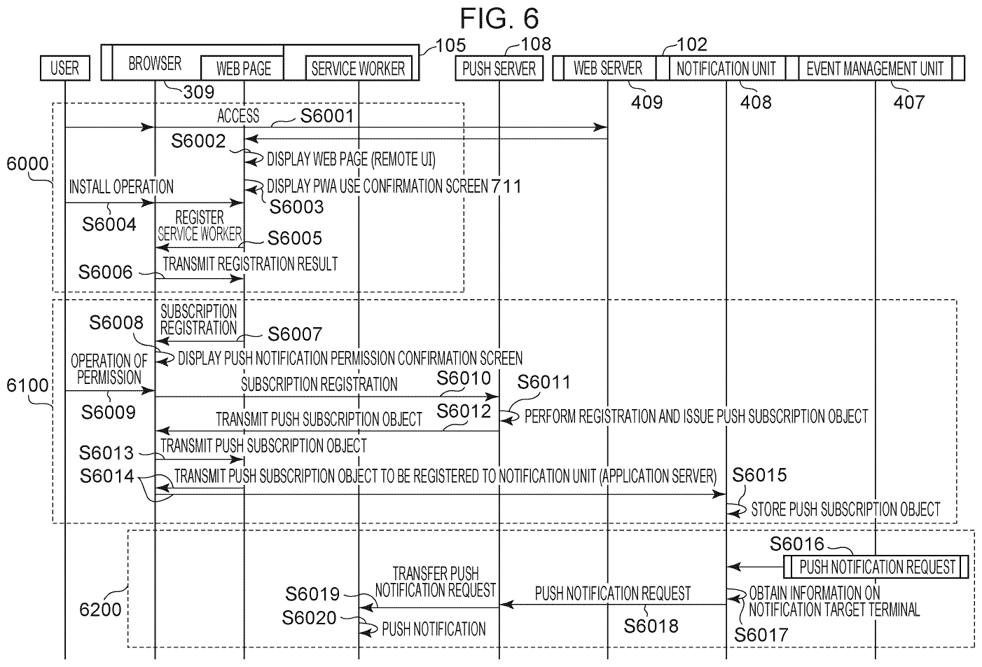

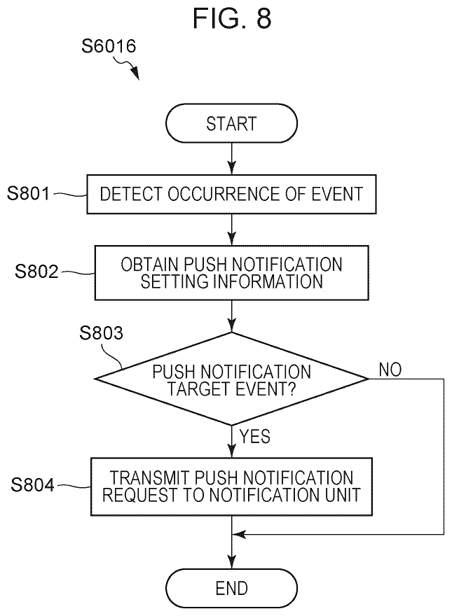

FIG. 2 is a diagram illustrating a hardware configuration of the image processing device 102. The image processing device 102 includes a central processing unit (CPU) 201, a read-only memory (ROM) 202, a random-access memory (RAM) 203, a storage device 204, a network interface (I/F) 205, an internal bus 206, a device controller 207, a printer 208, an input/output I/F 209, and an input/output device 210. The CPU 201 includes programs (including programs implementing the respective processes illustrated in FIG. 6 and FIG. 8 described below) stored in the ROM 202 and controls the individual devices in a centralized manner via the internal bus 206. The RAM 203 functions as a memory or work area of the CPU 201 and stores event information, various counter information, information on the consumption level of consumable parts, various logs, and so forth generated in the image processing device 102. The image processing device 102 may be a scanner device equipped with a scanner or may be a multifunction peripheral equipped with both a printer and a scanner.

The network I/F 205 performs one-way or two-way data communication with an external network device or PC via the LAN 101. The device controller 207 controls the printer 208 in accordance with a print request or the like. The CPU 201 performs a program execution process with the ROM 202 and the RAM 203 and also performs a process of recording image data on a recording medium such as the storage device 204. The storage device 204 functions as an external storage device and is capable of storing image data or the like and storing the above-described event information, various counter information, information on the consumption level of consumable parts, and various logs instead of the RAM 203.

The input/output device 210 receives an input (a scan input, a button input, or the like) from a user and transmits the input to the above-described processing units via the input/output I/F 209.

The storage device 204 also stores a program of a web server used to provide a PWA in addition to a remote UI, data of HyperText Markup Language (HTML) and script, information on related settings, and so forth.

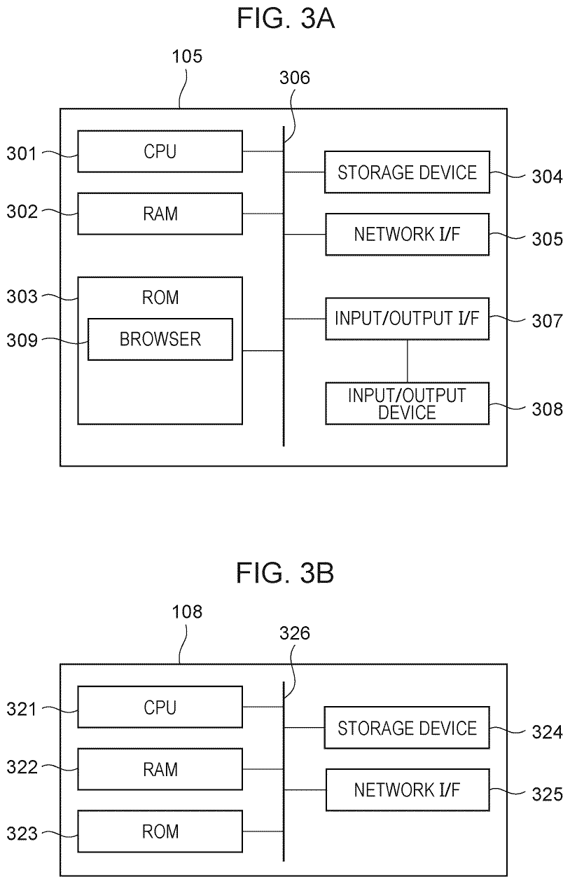

FIG. 3A is a diagram illustrating a hardware configuration of the terminal 105, and FIG. 3B is a diagram illustrating a hardware configuration of the push server 108.

FIG. 3A illustrates the hardware configuration of the terminal 105. The terminal 105 includes a CPU 301 that executes a program stored in a ROM 303 and that controls individual devices in a centralized manner via an internal bus 306. The program executed by the CPU 301 includes an application program of a web browser (a browser 309) or the like.

A RAM 302, the ROM 303, a storage device 304, a network I/F 305, and an input/output I/F 307 are connected to the internal bus 306. An input/output device 308 is an operation unit constituted by a keyboard, a cathode-ray tube (CRT), a liquid crystal display, or the like, and can be connected to the terminal 105 via the input/output I/F 307. The terminal 105 is capable of communicating with the image processing device 102 or the push server 108 by connecting to the Internet 107 via the network I/F 305 and further via the proxy server 103 and the firewall 104. A web page described below and data for implementing a service worker are downloaded from a network device to the ROM 303 or the storage device 304 and are stored therein.

FIG. 3B illustrates the hardware configuration of the push server 108. The push server 108 includes a CPU 321 that executes a program (including a program implementing the process of S6011, S6012, and S6019 illustrated in FIG. 6 described below) stored in a ROM 323 and that controls individual devices in a centralized manner via an internal bus 326. A RAM 322, the ROM 323, a storage device 324, and a network I/F 325 are connected to the internal bus 326. The push server 108 is capable of communicating with the image processing device 102 or the terminal 105 by connecting to the Internet 107 via the network I/F 325 and further via the proxy server 103 and the firewall 104.

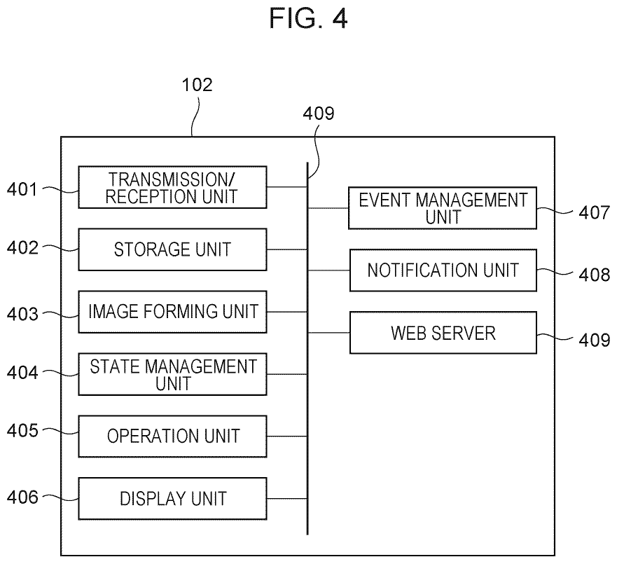

FIG. 4 is a diagram illustrating an example of a software module configuration of the image processing device 102.

The image processing device 102 includes a transmission/reception unit 401, a storage unit 402, an image forming unit 403, a state management unit 404, an operation unit 405, a display unit 406, an event management unit 407, a notification unit 408, and a web server 409.

The transmission/reception unit 401 transmits data processed by the image processing device 102 to the outside via a network. A protocol such as Simple Mail Transfer Protocol (SMTP), Hypertext Transfer Protocol/Hypertext Transfer Protocol Secure (HTTP/HTTPS), Simple Network Management Protocol (SNMP), File Transfer Protocol (FTP), or Server Message Block (SMB) is used in data transmission/reception. The transmission/reception unit 401 receives print data from a client device. The storage unit 402 performs storage control such as storing of information in the ROM 202, the RAM 203, or the storage device 204 and reading of information from the ROM 202, the RAM 203, or the storage device 204. The storage unit 402 also stores management information that is used to manage the image processing device 102. To be specific, the storage unit 402 stores firmware information, device configuration information such as an identification number of the image processing device 102, various counter information, information on the consumption level of consumable parts, an operation history of the image processing device 102, and history information (log data) representing various abnormal states, for example.

The image forming unit 403 has a function of generating and outputting print data to be transferred to the printer 208. The state management unit 404 manages print control and abnormal states of the image processing device 102, and also manages counter information and notification information. As the counter information, for example, a value obtained by counting the number of sheets printed by the image processing device 102 using a sensor or the like, and consumption level information indicating the consumption level of a part or the remaining amount of consumables such as a toner bottle, are stored in the storage unit 402 and are managed.

The operation unit 405 is an interface that enables a user to provide an operation instruction for the image processing device 102 such as a print instruction. The operation unit 405 controls display of state information of the image processing device 102, information on the consumption rate of various consumables (including remaining toner information), setting information, function buttons, and so forth using the display unit 406 and a display (not illustrated) of the image processing device 102.

The event management unit 407 manages event information in response to an event occurred in the image processing device 102. The event information managed by the event management unit 407 includes an event of a print job issued by a user of the image processing device 102, an error (also referred to as failure), and general status information of the image processing device 102. An error of the image processing device 102 is, for example, a highly urgent error such as a hard disk error, a paper jam, or a warning level error such as toner low. The event management unit 407 is notified of event information representing replacement of a tonner bottle, firmware update, and so forth. In addition, the event management unit 407 performs a process of issuing a push notification request to the notification unit 408 in response to detection of the occurrence of an event according to the embodiment of the present disclosure.

The notification unit 408 is implemented as a function of the application server mounted in the image processing device 102. The notification unit 408 issues data for a push notification to be provided to the terminal 105 as a notification target registered in advance, in response to receipt of a request from the event management unit 407. In response to receipt of a push notification request from the event management unit 407, the notification unit 408 edits data regarding the contents of notification into a predetermined format and transmits the data to the push server 108.

The information to be notified is information regarding the image processing device 102 (hereinafter referred to as device information), information regarding an event occurred in the image processing device 102, various counter information, information on the consumption level of consumable parts, or the like stored in the storage device 304. The device information includes identification information (serial number), network information (IP address), operation information, and so forth of the image processing device 102. Any piece of information is used for notification or the like in accordance with necessity.

The web server 409 is a module used by the image processing device 102 to provide a remote UI.

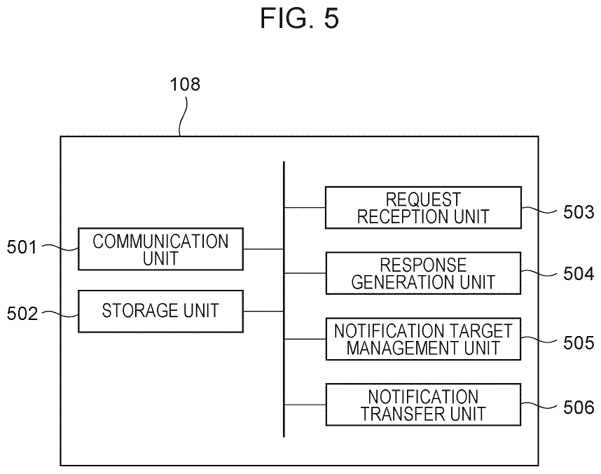

FIG. 5 is a diagram illustrating a software module configuration of the push server 108.

The push server 108 includes a communication unit 501, a storage unit 502, a request reception unit 503, a response generation unit 504, a notification target management unit 505, and a notification transfer unit 506.

The communication unit 501 has a function of communicating with the image processing device 102 or the terminal 105. The communication unit 501 receives a push notification request transmitted by the image processing device 102 and transmits a push notification to the terminal 105. The storage unit 502 performs storage control, such as read or write of information, on the RAM 322, the ROM 323, and the storage device 324. The target of storage control includes information on a terminal which is a target of push notification, and information on a push notification request.

The request reception unit 503 receives a request for registering the terminal 105 as a push notification target transmitted by the browser 309 of the terminal 105 and a push notification request transmitted by the notification unit 408. The response generation unit 504 transmits, as a response to the request for registering the terminal 105 as a push notification target, a push subscription object described below to the browser 309, which is a transmission source of the request. The notification target management unit 505 manages information on the terminal registered as a push notification target. To be specific, the information includes an identifier for identifying the target terminal and the push subscription object.

The notification transfer unit 506 transfers the push notification request received from the notification unit 408 to the notification target terminal, based on endpoint information included in the push notification request. The notification transferred to the terminal 105 by the notification transfer unit 506 in the present embodiment includes, for example, information on an error occurred in the image processing device 102, information on the consumption level of consumables, or a notice from an administrator.

FIG. 6 is a sequence describing an overview of an entire process executed in the network system. With reference to FIG. 6, a description will be given of a PWA install process (6000), a push notification target terminal registration process (6100), and a push notification process (6200) according to the present embodiment.

In the image processing device 102 according to an embodiment of the present disclosure, an administrator of the device is capable of setting in advance whether to permit the use of part of a function provided by the image processing device 102 (such as a function provided by a remote UI) as a PWA.

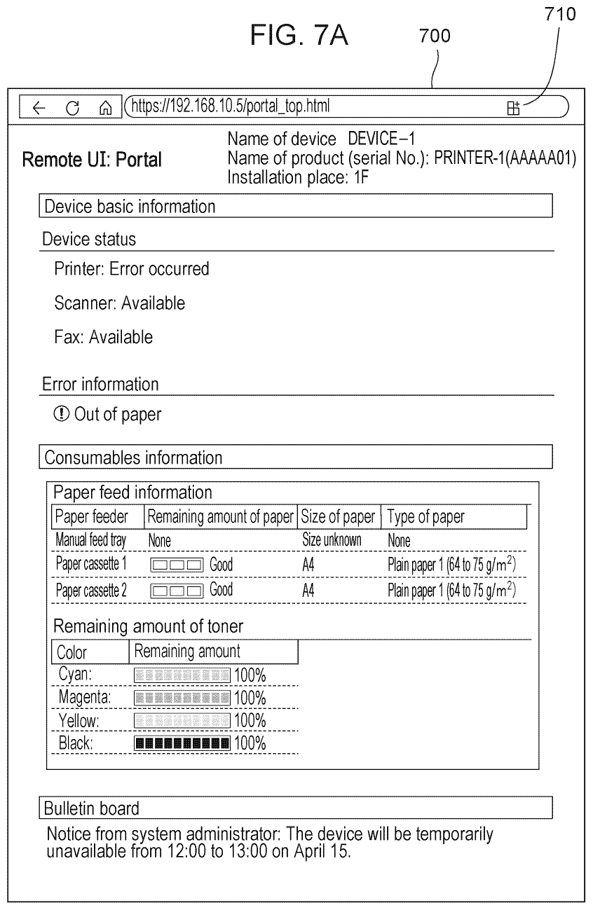

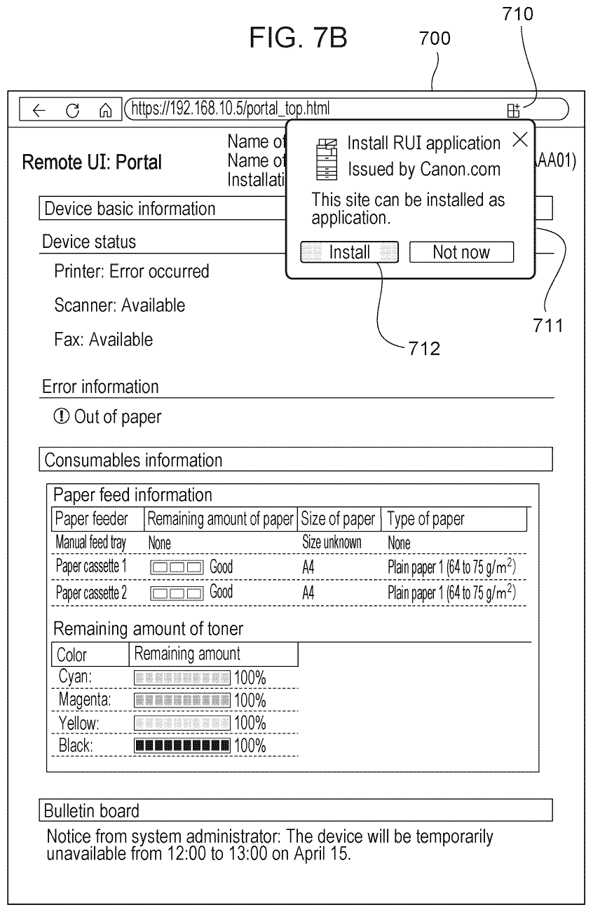

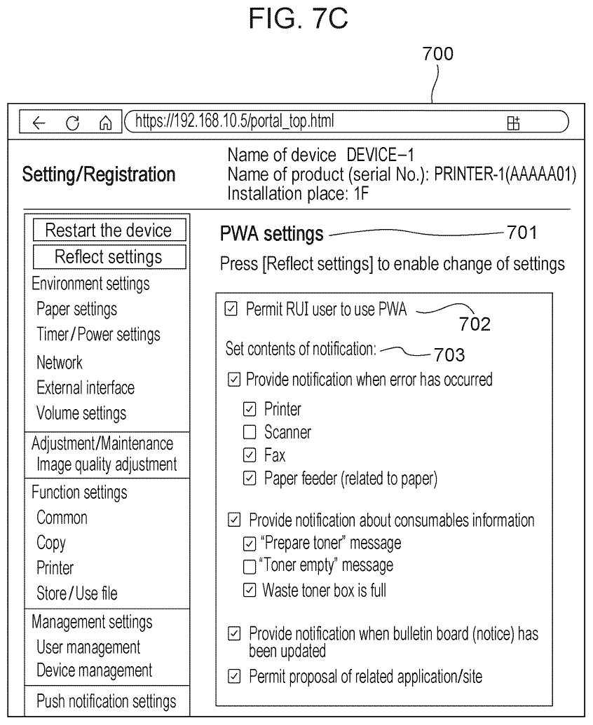

FIG. 7C illustrates an example of a setting screen for permitting the use of part of the function provided by the image processing device 102 as a PWA. This screen may be provided to a user having administrator rights of the image processing device 102. A window screen 700 illustrated in FIG. 7C is a screen of the browser 309 implemented by the terminal 105. The contents in the window screen 700 correspond to one of pages provided as a remoter UI as a result of accessing the image processing device 102 on the browser 309. The setting of whether to permit the use of part of the function provided by the image processing device 102 as a PWA may be made by the administrator via the operation unit 405 of the image processing device 102.

Reference numeral 701 on the setting screen illustrated in FIG. 7C denotes a setting area regarding the use of a PWA. Reference numeral 702 denotes a check box for permitting a user to use part of the function provided by the image processing device 102 as a PWA. Checking the check box 702 by the administrator enables the user of the image processing device 102 to use a PWA that can be downloaded via a remote UI. Reference numeral 703 denotes an area for setting the target of notification. The contents of notification provided from the image processing device 102 to the terminal 105 by the notification function of the PWA described below can be selectively set on a type basis. The types of contents of notification include errors, consumables information, bulletin board information such as a notice from the administrator, and proposal information of software or a website recommended by the vendor of the image processing device 102. The contents of notification selected here correspond to the target of the push notification function using the PWA.

Hereinafter, the PWA install process (6000) for the terminal 105 will be described.

In S6001, the browser 309 of the terminal 105 accesses the remote UI provided by the image processing device 102, based on an operation performed by a user. In S6002, the browser 309 downloads content data such as HTML data for the remote UI from the image processing device 102 via HTTPS communication, and displays the screen illustrated in FIG. 7A. The screen illustrated in FIG. 7A includes an icon 710 with which an instruction to install the PWA can be issued. In FIG. 6, the remote UI provided in the browser 309 is illustrated as a web page.

In S6003, the browser 309 provides a confirmation screen 711 illustrated in FIG. 7B in response to permission to use the PWA being set in advance on the screen illustrated in FIG. 7C and based on a user operation performed on the icon 710. The confirmation screen 711 is a screen for confirming whether the user is to use the PWA. Operating an install button 712 enables the PWA to be installed onto the terminal 105. That is, the install button 712 is an instruction button for downloading and installing a service worker and contents that are to be used to use at least part of the function provided by the image processing device 102 as the PWA.

In the present embodiment, the install makes it possible to use, in the terminal 105, an information providing function, a setting function, and so forth in the remote UI as an application of the PWA.

In S6004, the browser 309 detects that the install button 712 has been pressed by the user. Based on the detection, in S6005 after the PWA has been installed onto the terminal 105, the browser 309 registers the service worker downloaded from the image processing device 102 via the remote UI. The service worker is a program (JavaScript) defining behaviors such as reception of a push notification, operation in an offline state, and display of an icon on a home screen, which are features of the PWA on the terminal 105, and is executed in background separately from the web page provided in the browser 309. That is, a push notification for the installed PWA is implemented via the service worker operating in background even while the connection to the remote UI is not established in the browser 309. In S6006, after the registration process for the browser 309 has been completed, the browser 309 transmits a registration result (success or failure) to the web page and displays the result of the registration process.

Next, the push notification target terminal registration process (6100) will be described.

In S6007, the browser 309 receives, via the remote UI which is a web page that the browser 309 is accessing, a request for registering the terminal 105 as a push notification target terminal. The request corresponds to a push notification regarding the contents of notification in the area 703 illustrated in FIG. 7C. In S6008, the browser 309 displays a screen (not illustrated) for confirming whether the user permits a push notification. The browser 309 receives a user operation of permitting a push notification in S6009, and transmits to the push server 108 a request for registering the browser 309 of the terminal 105 as a push notification target in S6010.

In S6011, in response to receipt of the request by the request reception unit 503, the push server 108 registers the terminal 105 as a push notification target and issues a push subscription object by the notification target management unit 505.

The push subscription object connects the transmitter and the receiver of a push notification and includes information that is to be used by the notification unit 408 to transmit a push notification to the browser 309 of the terminal 105 of the user. To be specific, the push subscription object includes endpoint information of the push server that is to be used by the notification unit 408 to make a push notification request to the service worker of the notification target terminal via the push server 108. For example, the endpoint information is constituted by the URL of the push server, such as “endpoint”: https://test.pushserver.con/send/testEndPoint0001, and endpoint text that varies among terminals. In S6012, the response generation unit 504 of the push server 108 transmits, to the browser 309 as a request transmission source, the issued push subscription object as a response to the request for registering the push notification target.

In S6013, the browser 309 transmits the push subscription object to the web page, which is the remote UI. In S6014, the terminal 105 transmits the push subscription object to the notification unit 408, which is the application server of the image processing device 102, via the browser 309 in accordance with the script of the remote UI so that the push subscription object is registered.

In S6015, the notification unit 408 of the image processing device 102 stores the push subscription object in the storage unit 402. The push subscription object stored herein is used to transmit to the push server 108 a push notification request for the target terminal.

Next, the process of transmitting a push notification to a target terminal from the notification unit 408 of the image processing device 102 via the push server 108 (6200) will be described.

In S6016, the notification unit 408 receives from the event management unit 407 a push notification request regarding an event occurred in the image processing device 102. In S6017, the notification unit 408 obtains information on the notification target terminal from the storage unit 402.

Table A is a management table of notification target terminals managed in the storage unit 402 by the notification unit 408 of the image processing device 102. The information obtained from the push subscription object in the registration process in S6015 is managed. “Target terminal (endpoint)” represents endpoint information of individual terminals that is to be used to make a push notification request to the service worker of a notification target terminal. “Notification target flag” represents information indicating whether the individual terminals are push notification target terminals. “Date and time of update” represents the date and time when the flag is updated.

TABLE A
Notification target terminal management table

| Target terminal | Notification | Date and time of |
|---|---|---|
| (endpoint) | target flag | update |
| testEndPoint0001 | 1 (target) | May 1, 2024 17:05 |
| testEndPoint0002 | 1 (target) | May 1, 2024 17:05 |
| testEndPoint0003 | 1 (target) | May 1, 2024 17:05 |

The notification target flag is set to 1 (target) when the administrator of the image processing device 102 permits the use of the PWA (when the check box 702 is ON) and is set to 0 (non-target) when the administrator of the image processing device 102 does not permit the use of the PWA (when the check box 702 is OFF).

For example, when the check box 702 is changed to OFF after the information on the terminal 105 as a push notification target terminal has been registered, the flags of all the target terminals are updated to 0 (non-target). After that, the notification unit 408 does not generate a push notification request for the terminal 105 that is to be transmitted to the push server 108 even when receiving a request for a push notification from the event management unit 407.

In S6018, the notification unit 408 generates, based on the information on the notification target terminal obtained in S6017, a push notification request for the target terminal, and transmits the push notification request to the push server 108.

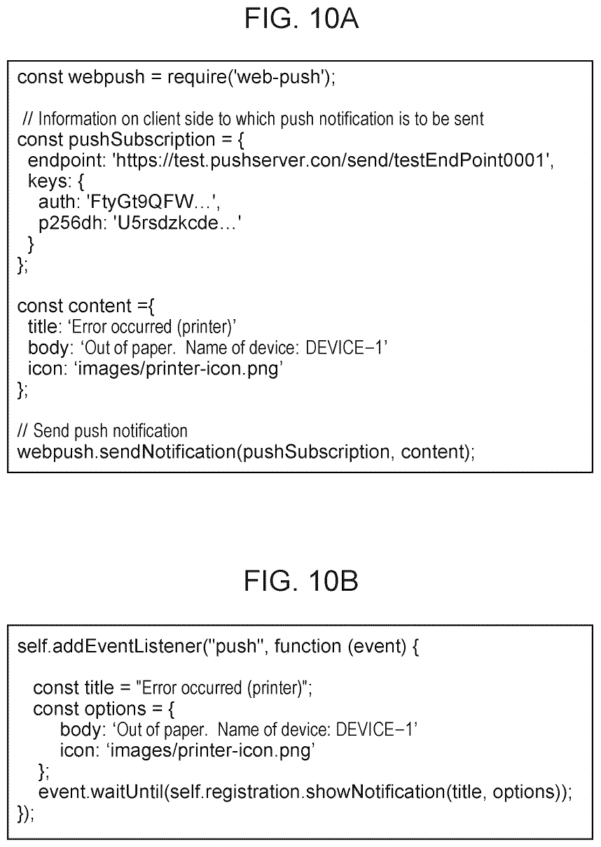

FIG. 10A illustrates an example of a program code (JavaScript) for generating a push notification request by the notification unit 408. The request includes the above-described push subscription object and component information of the push notification to be displayed on the terminal. In the component information of the push notification, “title” represents the title to be displayed on a notification banner, “body” represents character string information to be displayed on the body message of the notification banner, and “icon” represents the path of the icon image to be displayed together with the body message of the notification banner.

In S6019, the notification transfer unit 506 of the push server 108 transfers, based on the endpoint information included in the push notification request received by the request reception unit 503, the push notification request to the notification target terminal.

In S6020, the service worker provides, based on the received push notification request, display indicating that a push notification has been provided to the terminal 105. After that, the contents of the push notification are displayed on the installed PWA. FIG. 10B illustrates an example of a program code (JavaScript) for generating a push notification display request by the service worker. The request includes the above-described component information of the push notification. The PWA that has received an instruction of push notification from the service worker implements display based on the contents of the request.

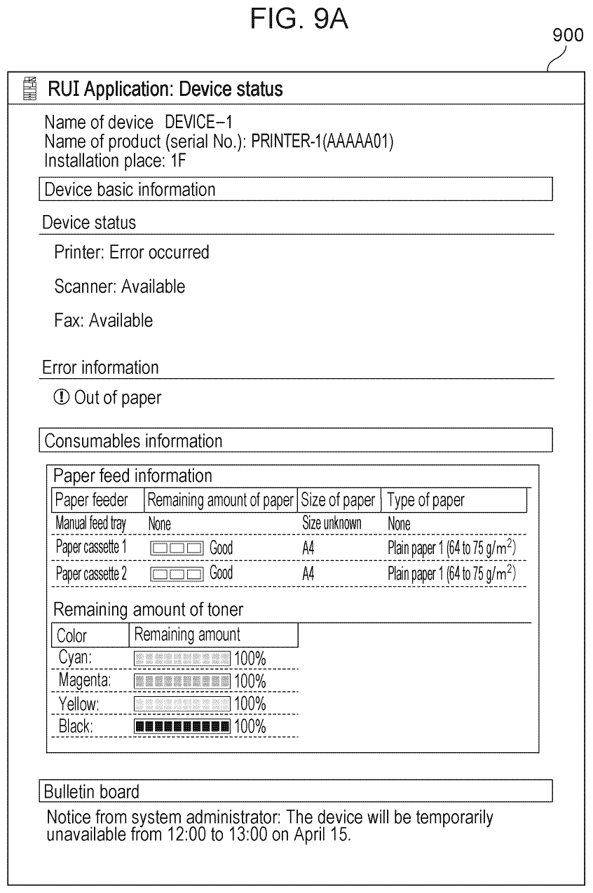

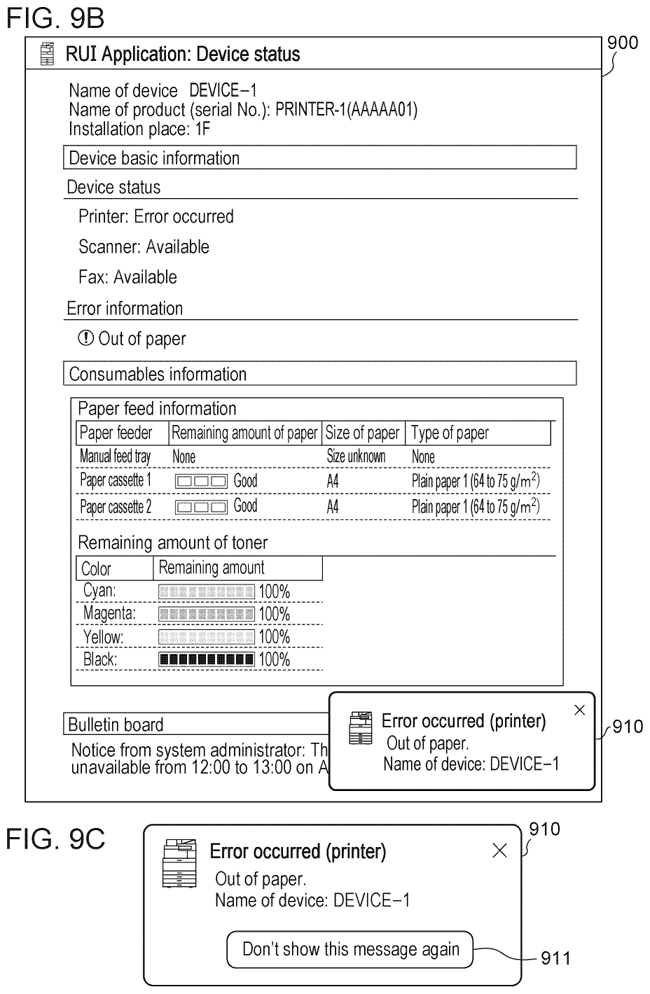

FIG. 9A illustrates an example of a screen 900 of the PWA displayed by the service worker. Unlike the screen 700 of the remote UI displayed on the browser 309 illustrated in FIG. 7A, the screen 900 of the PWA has a format of an ordinary application providing screen without an address bar. In this example, the screen 900 of the PWA provides part of the function of the remote UI. In accordance with the push notification in S6020, a notification 910 illustrated in FIG. 9B is displayed on the screen 900 of the PWA, and display based on the push notification by the service worker is implemented. As illustrated in FIG. 9B, it is understood that the notification based on the component information included in the push notification request is displayed.

FIG. 8 is a flowchart illustrating the details of the push notification request process (S6016) performed by the event management unit 407 of the image processing device 102.

In S801, the event management unit 407 detects the occurrence of an event. In S802, the event management unit 407 obtains push notification setting information in the image processing device 102 to determine whether the event is a target event of a push notification. Table B is an example of a notification target event management table managed by the notification unit 408 of the image processing device 102, and manages the contents set by the administrator in the area 703 illustrated in FIG. 7C. “Notification target event” represents information indicating a target event of push notification. “Flag” represents information indicating whether the individual events are notification targets. “Date and time of update” represents the date and time when the flag is updated.

TABLE B
Notification target event management table

| | | Date and time of |
|---|---|---|
| Notification target event | Flag | update |
| Error occurred (printer) | 1 (target) | May 1, 2024 17:05 |
| Error occurred (scanner) | 0 (non-target) | May 1, 2024 17:05 |
| Error occurred (fax) | 1 (target) | May 1, 2024 17:05 |
| Error occurred (paper feeder) | 0 (non-target) | May 20, 2024 13:11 |
| Consumables notification (prepare | 1 (target) | May 10, 2024 15:09 |
| toner) | | |
| Consumables notification (toner | 0 (non-target) | May 1, 2024 17:05 |
| empty) | | |
| Consumables notification (waste | 1 (target) | May 1, 2024 17:05 |
| toner box is full) | | |
| Bulletin board (notice) | 0 (non-target) | May 7, 2024 10:30 |
| Application proposal | 1 (target) | May 1, 2024 17:05 |

In S803, the event management unit 407 proceeds to S804 in response to determining that the detected event is set as a notification target, or ends the process in response to determining that the detected event is not a notification target. In S804, the event management unit 407 provides, to the notification unit 408, a request for a push notification for the notification target terminal.

### APPLICATION EXAMPLE

As described above, the information to be provided as a push notification can be set by the administrator of the image processing device 102, but there may be a notification message that is not necessary for a user. In the network system according to the present embodiment, a user is able to set, for each type of notification, a notification to a non-target of notification.

FIG. 9C illustrates a screen provided by the PWA, which is generated by expanding the push notification screen illustrated in FIG. 9B such that the notification can be set as a non-target of notification. In FIG. 9C, a button 911 indicating “Don't show this message again” is displayed on the notification 910. A user operation of the button 911 enables a setting to be made so that an instruction to make a push notification is not provided to the browser in S6020 even if a request for the notification is received thereafter.

Table C is a table for managing, for each type of notification, push notification targets managed by the service worker. “Type of notification” represents information indicating the type of push notification. “Notification target flag” represents information indicating whether the individual types of notification are push notification targets. “Date and time of update” represents the date and time when the flag is updated.

TABLE C
Notification target management table

| | Notification | Date and time of |
|---|---|---|
| Type of notification | target flag | update |
| Error occurred (printer) | 1 (target) | May 1, 2024 17:05 |
| Error occurred (scanner) | 0 (non-target) | May 1, 2024 17:05 |
| Error occurred (fax) | 1 (target) | May 1, 2024 17:05 |
| Error occurred (paper feeder) | 0 (non-target) | May 20, 2024 13:11 |
| Consumables notification (prepare | 1 (target) | May 10, 2024 15:09 |
| toner) | | |
| Consumables notification (toner | 0 (non-target) | May 1, 2024 17:05 |
| empty) | | |
| Consumables notification (waste | 1 (target) | May 1, 2024 17:05 |
| toner box is full) | | |
| Bulletin board (notice) | 0 (non-target) | May 7, 2024 10:30 |
| Application proposal | 1 (target) | May 1, 2024 17:05 |

Initial settings have the contents set by the administrator of the image processing device 102 in the area 703 illustrated in FIG. 7C. In response to detecting an operation of the button 911 via the PWA, the service worker identifies the type of notification from the component information (for example, title) of the push notification included in the push notification request received this time. Subsequently, the service worker sets the type of notification to a non-target of notification in the notification target management table in Table C. In response to receiving a push notification request in S6019, the service worker refers to the notification target management table in Table C and determines whether the received push notification request is a notification target in the terminal. In response to determining that the push notification request is a notification target event, the service worker instructs the browser 309 to make a push notification in S6020.

### Advantageous Effects of the Disclosure

In the above-described embodiment, at least part of the function provided by the network device (for example, the image processing device 102) can be provided as a PWA. Thus, a terminal permitted to use the PWA can be managed as a push notification target terminal. In particular, it becomes possible to detect an event information providing function of a remote UI or the like provided by the image processing device 102 and provide a push notification to a user without accessing the image processing device 102 by a user operation in a web browser or the like. This effect is very remarkable in device management in providing a notification useful to the user.

In addition, the PWA can be downloaded and installed between the terminal 105 and the network device without registration in the application store of the vender that provides the operating system of the terminal 105. Thus, in a use case of performing simple device management, software can be released with less time and effort of both the user and the vendor that provides the PWA.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-112525, filed Jul. 12, 2024, which is hereby incorporated by reference herein in its entirety.

What is claimed is:

1. A network device comprising:
one or more memories storing instructions; and
one or more processors capable of executing the instructions causing the network device to:
provide a web page to a web browser via a network; and
detect an event corresponding to information displayed on the web page,
wherein the web page provided to the web browser executed by a terminal is a web page where a web application is installable onto the terminal in accordance with a user's predetermined operation performed on the web browser, and
wherein the web application has at least part of a function provided by the network device.

2. The network device according to claim 1,
wherein the instructions cause the network device to provide, as one setting screen of the web page, a setting screen where a setting to permit the user to use the web application is able to be made.

3. The network device according to claim 1,
wherein the web application supports a function for making a push notification of information regarding the event detected by the network device, and
wherein a service worker for implementing the push notification is registered in the terminal when the web application is installed onto the terminal.

4. The network device according to claim 3,
wherein the instructions cause the network device to provide, as one setting screen of the web page, a setting screen where an event which is a target of the push notification is able to be set.

5. The network device according to claim 3,
wherein the instructions cause the network device to provide, as one setting screen of the web page, a setting screen where provision of information regarding at least one of a notice from an administrator, a proposal of software, and a proposal of a website is able to be set as a target of the push notification.

6. The network device according to claim 3,
wherein the push notification is provision of information regarding at least one of an error of the network device and consumables information.

7. The network device according to claim 3,
wherein the instructions further cause the network device to transmit a request for the push notification to a push server, and
wherein the push notification is transmitted from the push server to the service worker in accordance with the request.

8. The network device according to claim 1,
wherein the network device includes a printer, and
wherein the information displayed on the web page includes information regarding consumables used in the printer.

9. The network device according to claim 1,
wherein the network device is any one of a network router, a surveillance camera, and a digital medical device.

10. The network device according to claim 1,
wherein the network device is an image processing device including at least one of a printer and a scanner.

11. A control method for a network device, the control method comprising:
providing a web page to a web browser via a network; and
detecting an event corresponding to information displayed on the web page,
wherein the web page provided to the web browser executed by a terminal is a web page where a web application is installable onto the terminal in accordance with a user's predetermined operation performed on the web browser, and
wherein the web application has at least part of a function provided by the network device.

12. A non-transitory computer readable storage medium on which is stored a computer program for executing a method for a network device that is capable of detecting an event corresponding to information displayed on a web page, the method comprising:
providing a web page to a web browser via a network,
wherein the web page provided to the web browser executed by a terminal is a web page where a web application is installable onto the terminal in accordance with a user's predetermined operation performed on the web browser, and
wherein the web application has at least part of a function provided by the network device.
